(19) United States
(12) Patent Application Publication
(10) Pub. No.: US 2018/0152528 A1
(43) Pub. Date: May 31, 2018

(54) SELECTION SYSTEMS AND METHODS

(71) Applicant: Microsoft Technology Licensing, LLC, Redmond, WA (US)

(72) Inventors: Rahul Gupta, Hyderabad (IN); Pradeep Kumar Reddy K, Hyderabad (IN); Bhavesh Sharma, Hyderabad (IN)

(73) Assignee: Microsoft Technology Licensing, LLC, Redmond, WA (US)

(21) Appl. No.: 15/361,578

(22) Filed: Nov. 28, 2016

(51) Int. Cl. H04L 29/08; G06N 99/00; G06N 5/02

(52) U.S. Cl. CPC H04L 67/22; H04L 67/02; G06N 5/02; G06N 99/005

(57) ABSTRACT

Systems and methods for intelligent application selection are provided. The systems and methods utilize augmentation application preferences, user application preferences and/or world application preferences to select an application for opening a uniform resource identifier (URI).

### BACKGROUND

Uniform resource identifiers (URIs) are a ubiquitous part of emails and conversation today where people send links to one another. User devices may have one or more browsers, media players, or other type-specific applications installed on their computing system for opening URIs. For example, when the URI is a uniform resource location (URL), the user device utilizes a web browser, such as Internet Explorer, Chrome, Firefox, etc., to open the URL. When a user clicks on a URL hyperlink, either the system URL mapper shows the user an option to select one of the multiple browsers on the computing device or takes the user to a default browser to open the URL. If the user has not selected a default browser, the user has to do an extra click every time to select which browser on the computing device will open the URL. In other cases, if the user has already selected a default browser for the system, then all URLs go to the same browser, even though the default browser might not be the best or even compatible with a selected URL.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to intelligent application selection. As such, the systems and methods as disclosed herein utilize augmentation application preferences, user application preferences and/or world application preferences to select an application for opening a uniform resource identifier (URI). The ability of the systems and methods as disclosed herein to intelligently select the best application based on augmentation application preferences, user application preferences and/or world application preferences improves the performance or retrieval of the URIs and/or improves user interactions with the user's devices during retrieval of the URI when compared to previously utilized systems or methods that do not utilize augmentation application preferences, user preferences, and/or world knowledge to select an application for opening a given URI.

One aspect of the disclosure is directed to a system for intelligent application selection. The system includes at least one processor and a memory. The memory encodes computer executable instruction that, when executed by the at least one processor, are operative to:
receive a uniform resource identifier (URI) selection for a URI;
extract a domain from the URI selection;
extract any URI augmentation from the URI selection;
collect user application preferences associated with the domain;
collect world application preferences associated with the domain;
rank any extracted URI augmentation, the user application preferences, and the world application preferences;
select an application for opening the URI based on the ranking; and
open the URI using the application.

Another aspect of the disclosure is directed to a system for intelligent application selection. The system includes at least one processor and a memory. The system includes at least one processor and a memory. The memory encodes computer executable instruction that, when executed by the at least one processor, are operative to:
receive a uniform resource identifier (URI) selection for a URI;
extract a domain from the URI selection;
collect user application preferences associated with the domain;
collect world application preferences associated with the domain;
rank the user application preferences and the world application preferences;
select an application for opening the URI based on the ranking; and
provide a prompt to a user requesting approval to open the URI using the application.

Yet another aspect of the disclosure includes a method for intelligent application selection. The method includes:

receiving a uniform resource identifier (URI) selection for a URI;

extracting a domain from the URI selection;

determining whether any URI application augmentation is associated with the URI;

in response to determining that the URI is not associated with a URI application augmentation:
collecting user application preferences associated with the domain;
collecting world application preferences associated with the domain;
ranking the user application preferences and the world application preferences;
selecting an application for opening the URI based on the ranking; and
opening the URI using the application.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1 is a schematic diagram illustrating an application selection system on a client computing device, in accordance with aspects of the disclosure.

FIG. 2 is a schematic diagram illustrating an application selection system on a server computing device being utilized by a user via a client computing device, in accordance with aspects of the disclosure.

FIG. 3 is a simplified schematic block diagram illustrating the use of an application selection system by a user, in accordance with aspects of the disclosure.

FIG. 4 is a block flow diagram illustrating a method for application selection, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 6A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

Currently, a user device opens each URI using the same selected default application or opens each URI using a default application that is selected by the user each time a URI selection is received. The default application may not be the best application or compatible application for opening the URI. Further, requiring the user to select a desired application each time a URI selection is received slows down processing and retrieval times for the opening of the URI. Additionally, the user may not know which application is compatible with or better for opening a given URI.

Therefore, systems and methods for intelligent application selection are disclosed herein. The systems and methods as disclosed herein utilizing augmentation preferences, user preferences and/or world preferences to determine an application for opening a specific URI. Accordingly, the systems and methods as disclosed herein provide an intelligent URI mapper that automatically gets trained through user actions performed on his or her devices. The ability of the systems and methods described herein to intelligently select the best application based on augmentation preferences, user preferences, and/or world knowledge improves the performance or retrieval of the URIs and/or improves user interactions with the user's devices during retrieval of the URI when compared to previously utilized systems or methods that do not utilize augmentation preferences, user preferences, and/or world knowledge to determine an application for opening a given URI.

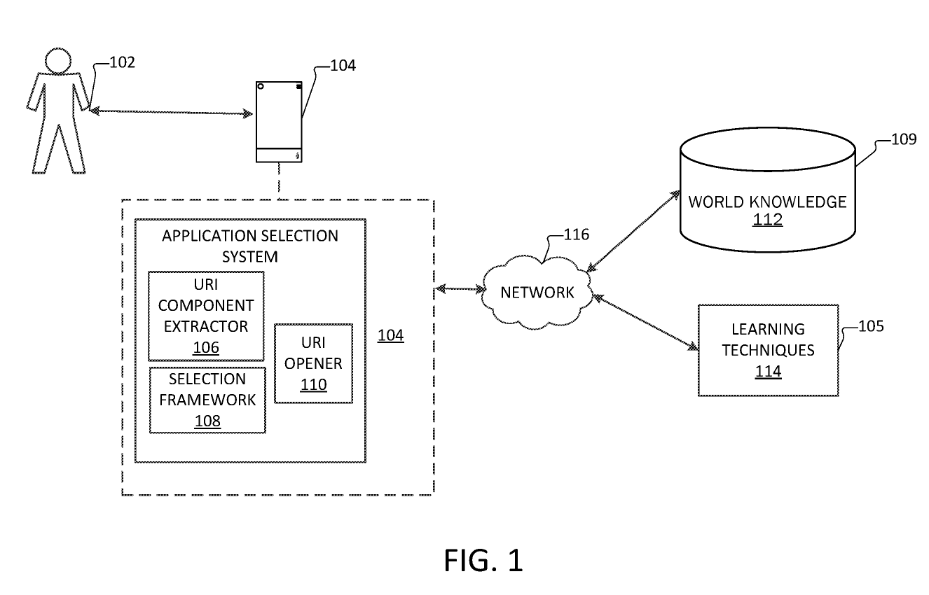

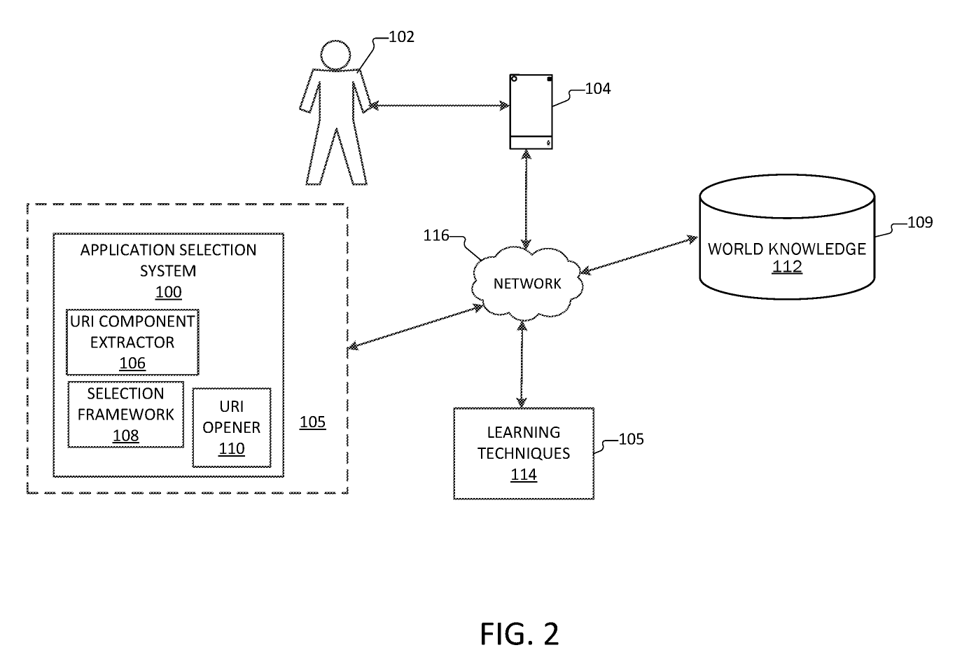

FIGS. 1-2 illustrate different examples of an intelligent application selection system 100 that intelligently selects an application for opening a URI on a client computing device 104 being utilized by a user 102, in accordance with aspects of the disclosure. The URI may be any part of any sub-component process on the operating system layer. In some aspects, the intelligent application selection system 100 is implemented on the client computing device 104 as illustrated in FIG. 1. In a basic configuration, the client computing device 104 is a computer having both input elements and output elements. The client computing device 104 may be any suitable computing device for implementing the intelligent application selection system 100. For example, the client computing device 104 may be a mobile telephone, a smart phone, a tablet, a phablet, a smart watch, a wearable computer, a personal computer, a gaming system, a desktop computer, a laptop computer, and/or etc. This list is exemplary only and should not be considered as limiting. Any suitable client computing device 104 for implementing the intelligent application selection system 100 may be utilized.

In other aspects, the intelligent application selection system 100 is implemented on a server computing device 105, as illustrated in FIG. 2. The server computing device 105 may provide data to and/or receive data from the client computing device 104 through a network 116. In some aspects, the network 116 is a distributed computing network, such as the internet. In further aspects, that intelligent application selection system 100 is implemented on more than one server computing device 105, such as a plurality or network of server computing devices 105. In some aspects, the intelligent application selection system 100 is a hybrid system with portions of the intelligent application selection system 100 on the client computing device 104 and with portions of the intelligent application selection system 100 on the server computing device 105.

The intelligent application selection system 100 includes a URI component extractor 106, a selection framework 108, and a URI opener 110. The intelligent application selection system 100 collects a URI selection from user input via a client computing device 104. In some aspects, the user input is collected via or over the network 116. Further, the intelligent application selection system 100 may collect world knowledge 112 from one or more databases 109 via the network 116. World knowledge 112 as utilized herein includes any information that can be accessed utilizing a network connection, such as search engines and databases. Additionally, the intelligent application selection system 100 may collect learning techniques 114 from servers 105 and/or databases 109 via the network 116. The term collect as utilized herein refers the active retrieval of items and/or to the passive receiving of items.

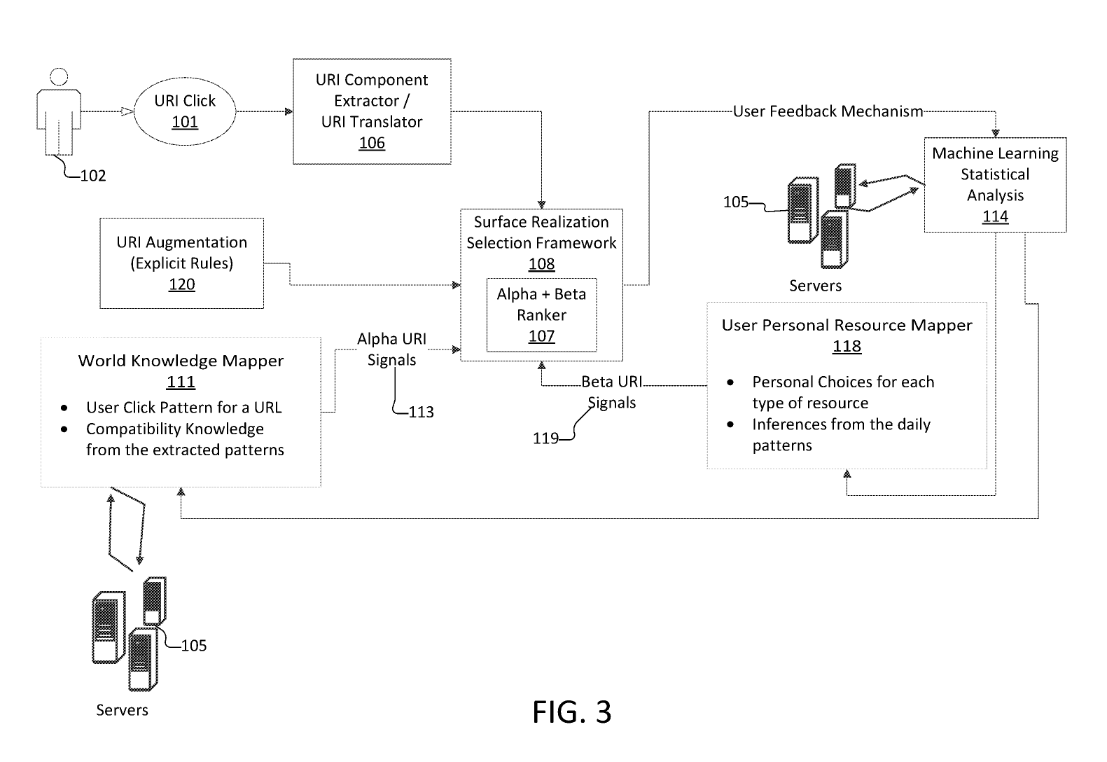

FIG. 3 is an example of a simplified schematic block diagram illustrating the use of an intelligent application selection system 100, in accordance with aspects of the disclosure. In response to receiving a URI click 101 or URI selection 101 of a URI by the user 102, the URI component extractor 106 of the application selection system 100 is triggered. The URI component extractor 106 extracts components of the URI. The components of the URI include domains, augmentations, query parameters, protocols, etc. In some aspects, the URI component extractor 106 extracts domains and any augmentations from the URI. Augmentations as utilized herein refer to any explicit rules associated with the URI. The explicit rules are typically added to the URI by the creator of the URI. For example, the explicit rules may allow the creator of the URI to require that a specific application be utilized to open the URI. The URI component extractor 106 may also include a URI translator. The URI translator decodes the URI of the URI selection. The URI component extractor 106 passes all the extracted information to the selection framework 108.

The selection framework 108 of the intelligent application selection system 100 analyzes the collected extracted information. The selection framework 108 checks for or extracts any URI augmentation determinations for the URI of the URI selection. If the URI component extractor 106 determines or finds that the URI was augmented, then the selection framework 108 collects the rules associate with the augmentation 120. In some aspects, the selection framework 108 collects the rules associated with an augmentation 120 by sending a query or a look up call to the cache or online server, if rules are not in the cache. The rules may indicate that the URI should be opened utilizing a specific application. In some aspects, if the rules indicate that the URI should be opened utilizing a specific application, the selection framework 108 selects that specific application to open the URI and send this selection to the URI opener 110. For example, a creator of the URI may control the application or browser that is utilized to host the URI by creating a URI argumentation 120. Alternatively, if the URI component extractor 106 determines that the URI was not augmented based on the augmentation determination or determines that the rules associated with an augmentation do not indicate that the URI should be opened utilizing a specific application, then the selection framework 108 utilizes user preferences and/or world preferences to select an application to open the URI. In alternative aspects, the selection framework 108 does not check for an augmentation determination and does not select an application to open the URI based on the augmentation. In still further aspects, the augmentation preferences are weighted and ranked by ranker 107 with the user application preferences and the world application preferences.

The selection framework 108 takes a collected domain and sends a query or a look up call to the cache or online server, if it is not in cache, to determine the best possible application to open the URI based on the world preferences and/or user preferences. The surface realization selection framework 108 builds its knowledge (user preferences and/or world preferences) from two different sources tagged as alpha URI signals 113 and beta URI signals 119 as illustrated in FIG. 3.

The beta URI signals 119 are collected from a user personalized resource mapper 118. The user personalized resource mapper 118 determines user preferences (or one or more user preferred applications for opening a given URI) utilizing learning techniques based on the user's personal behavior pattern and/or user feedback. The personal behavior patterns of the user are determined based on daily application selection patterns, user application choices, and/or application choice patterns for specific domains of URIs. The user personalized resource mapper 118 and/or the selection framework 108 may track and/or receive daily application selection patterns, user application choices, and/or application choice patterns for specific domains of URIs. Additionally, the user personalized resource mapper 118 consider different factors of the applications that could affect user application choices and patterns, such as if an application is newly downloaded and, therefore, may not have high use rate.

The user feedback may be explicit or implicit from the user 102. Explicit feedback is when the user provides comments on a provided application for opening a URI. For example, the user 102 may select or input a request not to utilize a given application again for a given URI or domain. In contrast, implicit feedback is the monitoring of user behavior in response to the opening of URI in a given application. For example, the selection/non-selection, the duration of use, and/or the pattern of use of URI may be monitored to determine user feedback. For instance, if the URI is reopened in another application, this feedback can be monitored to determine that the provided application was undesirable to the user 102 for some reason.

In these aspects, the application determined by the user personalized resource mapper 118 based on the user's personal behavior pattern and/or user feedback is sent to the selection framework 108 via the beta URI signals 119. The learning techniques may be machine learning techniques, statistical modeling techniques, and/or a learning algorithm. In some aspects, these learning techniques are collected from the world knowledge 112. In some aspects, the user application preferences for a given URI may be overridden by the user's personal default selection. In these aspects, the application selected by the user personalized resource mapper 118 and sent to the selection framework 108 via the beta URI signals 119 is the default selection. In other aspects, a selected default application may not be utilized or selected by the user personalized resource mapper 118 based on the user's personal behavior pattern and/or user feedback.

The alpha URI signals 113 are collected from a world knowledge mapper 111. The world knowledge mapper 111 utilizes world knowledge 112 to get one or more preferred applications for opening of a given URI. The world knowledge 112 is built using learning techniques 114 based on world user behavior patterns. The world user behavior patterns are determined based on the monitoring or tracking of world user click patterns for any given URI. Further, compatibility schemas or knowledge may be determined or extracted from the world user behavior patterns utilizing the learning techniques 114. Additionally, the world knowledge mapper 111 may also consider different factors of the applications that could affect user application choices and patterns, such as if an application is only newly release and, therefore, may not have high use rate. The compatibility schemas may be utilized to build the world knowledge 112. The compatibility schemas help to decide if a given URI can be opened on a particular application. For example, flash websites do not efficiently run on old versions of Internet Explorer. The world knowledge mapper 111 determines or selects one or more applications to open the URI based on the world knowledge 112 and sends this/these one or more applications to the selection framework 108 in alpha URI signals 113.

Additionally, consider factors of newly released applications, such as newly launched or installed.

The ranker 107 dynamically weighs the alpha URI signals 113 and the beta URI signals 119. The dynamic weighing of ranker 107 may keep changing based on integration with the URI and user feedback mechanism, which is used by a cognitive learning component that may be built on a layer consisting of statistical analysis and machine learning modules for re-training. These learning techniques 114 may run offline on remote servers. In other words, each of the signals is assigned a weight based on the confidence level of the learning techniques 114 and other factors. For example, if the user is new to the selection framework 108 or if there is no preferred default application associated with a particular URI for the user, the user preferences or beta URI signal 119 may be given a low weight. In another, example, if the world knowledge 112 shows that a specific application is not suitable for opening a given URI link, this software application has a null weight (or do not use signal) with a very high weight. In another example, the world application preferences are ranked above the user application preferences when the user application preferences are based on very little or no user feedback and very little or no user application patterns, such as when the user is new to the selection framework 108.

In some aspects, the ranker 107 collects and ranks augmentation application preferences. In these aspects, the augmentation with associated software application (also referred to herein as URI application augmentations) are given the highest weights and ranked above the alpha signals 113 and above the beta signals 119. In further aspects, if an augmentation 120 has no associated software application or if no augmentation is determined, this augmentation application preference is given the lowest weight possible and/or ranked below the alpha signals 113 and below the beta signals 119. In alternative aspects, the beta URI signals 119 (or user preferences) are always ranked above the alpha signals 113 (or world preferences), and known augmentation applications are always ranked above the beta URI signals 119. In other alternative aspects, the beta URI signals 119 (or user preferences) are ranked above the alpha signals 113 (or world preferences), when the beta URI signals 119 are ranked above a predetermined threshold. As such, in these aspects, the alpha signals 113 are only ever utilized to select the application when the beta signals 119 and an associated augmentation application are not present. In alternative aspects, all preferences are ranked based solely on their weight and any preference may be ranked above another.

The URI opener 110 helps the host to control the opening of URI in a particular application. The “open” or “opening” of the URI as utilized herein refers to performance of any action on the URI, such as editing, printing, saving, opening, etc. For example, if a user has a default browser set to Firefox, but the host wants the user to open an intranet website in Internet Explorer because the website is not compatible with other browsers, the URI opener 110 can make the client computing device use Internet Explorer to open the URI. In alternative aspects, the URI opener 110 does not automatically open the URI based on the application selection, but instead sends a prompt to the user 102 and requests user 102 approval to open the URI utilizing the selected application. In further aspects, the URI opener 110 only prompts the user for permission when the selected application is different than a user default application for opening the given URI. In these aspects, the URI opener 110 opens the URI utilizing the selected application in response to user approval and does not open the URI using the selected URI in response to receiving a user rejection of the selected application. In response to receiving a user rejection, the URI opener opens the URI in an application selected by the user or in a user set default application.

In some aspects, the URI is a URL. In these aspects, the intelligent application selection system 100 has to a select web browser (or web interface application) based on the domain. In other aspects, the URI is a file that has be opened in specific kind of application, such as media player, word processing, spreadsheet, and/or presentation application. This list is exemplary only. Any other suitable application for opening a link to a file may be utilized by intelligent application selection system 100. In these aspects, the intelligent application selection system 100 has to select a media player application, spreadsheet application, or presentation application based on the determined domain. In other words, the domain determines or identified the type of application needed for opening the URI.

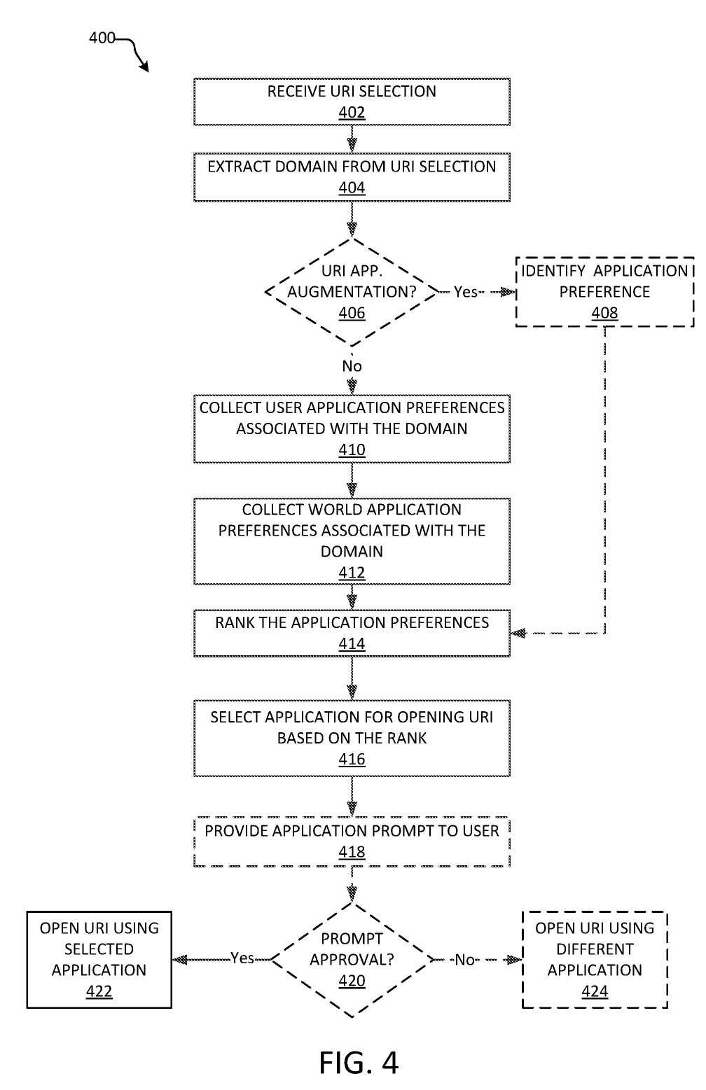

FIG. 4 illustrates a flow diagram conceptually illustrating an example of a method 400 for intelligence application selection. In some aspects, method 400 is performed by the intelligent application selection system 100 as described above. Method 400 provides a system for selecting application based on user preferences and/or world preferences unlike previously utilized application selection systems.

Method 400 includes receive operation 402. At receive operation 402, a user click or selection of a URI is received. In response to receiving a user selection of a URI at receive operation 402, extract operation 404 is performed. At extract operation 404, a domain from the URI selection is extracted.

In some aspects, method 400 includes decision operation 406 and identify operation 408. At decision operation 406, a determination is made as to whether any URI augmentation for an application is associated with the domain. The augmentation is determined during decision operation 406 by extracting the augmentation from the domain. Next, a determination is made as to whether a determined augmentation requires use of a specific application for the domain at decision operation 406. The determination is made by collecting and analyzing rules associated with a determined augmentation at decision operation 406. If a specific application is required by the rules of the augmentation, decision operation 406 selects to perform identify operation 408. If a specific application is not required by the rules of the augmentation or if an augmentation is not found, decision operation 406 selects to perform user preferences operation 410.

At identify operation 408, an application recommended (or preferred) by the URI augmentation is identified. The recommended application may be identified at identify operation 408 by analyzing the rules of the URI augmentation. While FIG. 4 illustrates that rank operation 414 is performed after identify operation 408, in alternative aspects, user preferences operation 410 or selection operation 416 is performed directly after identify operation 408.

At user preferences operation 410, the user application preferences associated with the domain are collected. The user application preferences are determined based on analysis of one or more of the following user inputs: user personal application choices for each resource or domain, inferences from a user daily application choices, and/or user feedback. These user inputs may be analyzed utilizing machine learning techniques and/or statistical analysis techniques. This analysis will result in an identification of one or more applications for opening the URI. The identified one or more application are the user preferences or user application preferences.

At world preferences operation 412, the world application preferences associated with the domain are collected. The world application preferences are determined based on, for example, an analysis of the following world inputs: tracking of world users' click patterns for a URI and application compatibility information (which may be extracted from the world users' click patterns, provided by application developers or reviewers, etc.). These user patterns may be analyzed utilizing machine learning techniques and/or statistical analysis techniques. This analysis will result in an identification of one or more applications for opening the URI in line with the world preferences or world application preferences.

While user preferences operation 410 and world preferences operation 412 are displayed in a specific order with relation to each other in FIG. 4, these operations may be performed in any order, may overlap in performance, or may be performed simultaneously.

Method 400 also includes rank operation 414. In some aspects, rank operation 414 is performed after identify operation 408. In other aspects, rank operation 414 is performed after user preferences operations 410 and/or after world preferences operation 412.

At rank operation 414, the user application preferences, the world application preferences, and/or the identified application preference are ranked. In some aspects, the user preferences, the world preferences, and/or the identified application preference are ranked by assigning weights to the different preferences based on confidence levels determined by the leaning techniques at rank operation 414. For example, a dynamic weighing mechanism may be performed at rank operation 414 may keep changing based on integration with the URI and user feedback mechanism that is used by cognitive learning component, which is built on a layer consisting of statistical analysis and machine learning modules for re-training and runs offline on remote servers to rank the application preferences. In some aspects, the lack of an application augmentation is assigned a weight at rank operation 414 for ranking. In some aspects, the identified application preference is assigned a weight at rank operation 414 for ranking.

In other aspects, user application preferences are always ranked above world application preferences. In some aspects, an identified application preference is always ranked above user application preferences and world application preferences. In further aspects, if an identified application preference is not found at identify operation 408, this non-preference is always ranked below user application preferences and world application preferences.

After rank operation 414, selection operation 416 is performed. At selection operation 416, an application for opening the URI is selected based on the ranking. In some aspects, the application with the highest ranking is selected at selection operation 416. In other aspects, one of the highest ranking applications is selected at selection operation 416.

In some aspects, open operation 422 is performed after selection operation 416. At open operation 422, the URI is opened using the application selected at selection operation 416.

In other aspects, method 400 includes a provide operation 418, an approval operation 420, and a different operation 424. At provide operation 418, a prompt is provided to the user requesting approval to open the URI using the application selected at selection operation 416. A user response to the prompt is received and a determination is made as to whether to perform different operation 424 or open operation 422 based on the response at approval operation 420. If the received response is an approval of the prompt by the user, approval operation 420 performs open operation 422. If the received response is a rejection of the prompt by the user, approval operation 420 performs different operation 424.

At different operation 424, the URI is open using an application that is different than the application selected at selection operation 416. In some aspects, different operation 424 receives user input or selection of the different application and, in response to this input or selection, the different application is utilized to open the URI at different operation 424. In other aspects, a default application based on the domain is automatically chosen as the different application at different operation 424. The different application is utilized to open the URI at different operation 424.

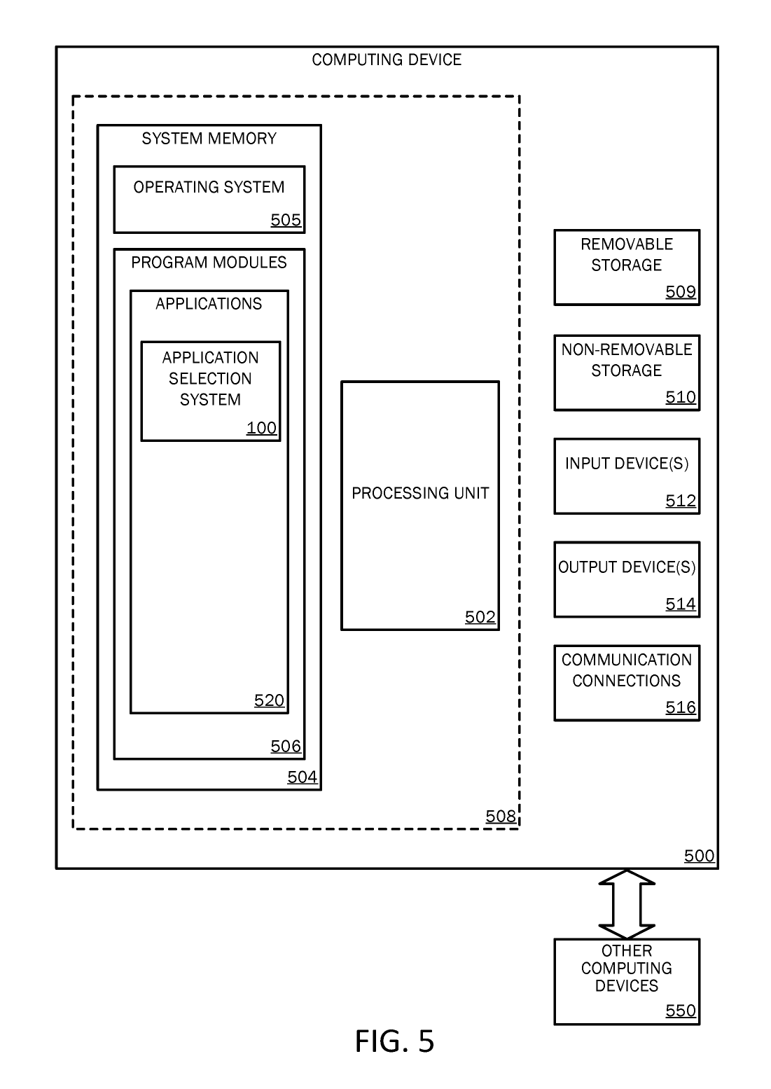

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, the intelligent application selection system 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for the intelligent application selection system 100 that can be executed to employ method 400 to provide intelligence application selection.

In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510. For example, the stored session information and/or the multi-domain multi-turn tasks and/or the multi-turn multi-domain NLU data could be stored on any of the illustrated storage devices.

As stated above, a number of program modules and data files may be stored in the system memory 504. While executing on the processing unit 502, the program modules 506 (e.g., the intelligent application selection system 100) may perform processes including, but not limited to, performing method 400 as described herein. For example, the processing unit 502 may implement the intelligent application selection system 100. Other program modules that may be used in accordance with aspects of the present disclosure, and in particular to generate screen content, may include a media player application, a file sharing application, a communication application, a mapping application, a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

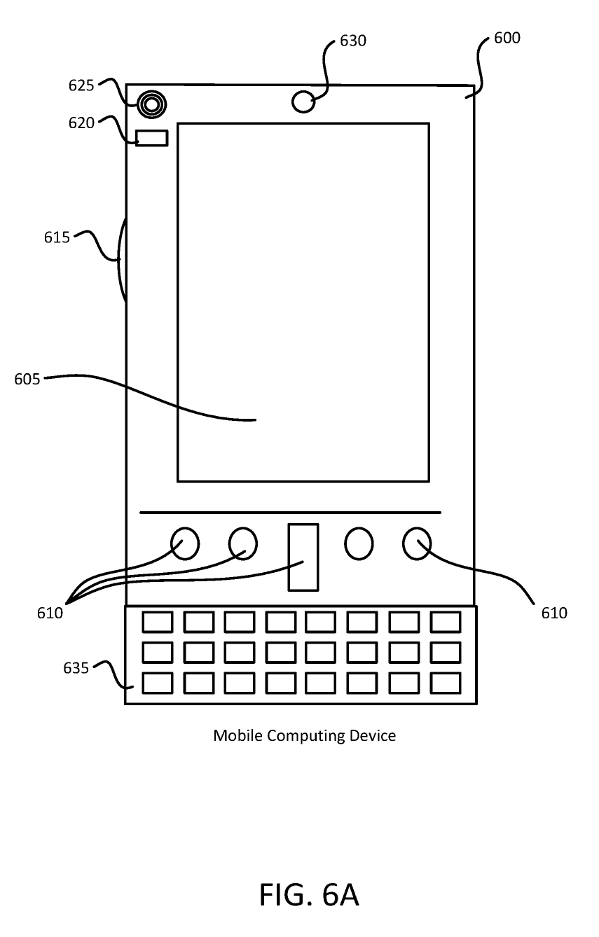

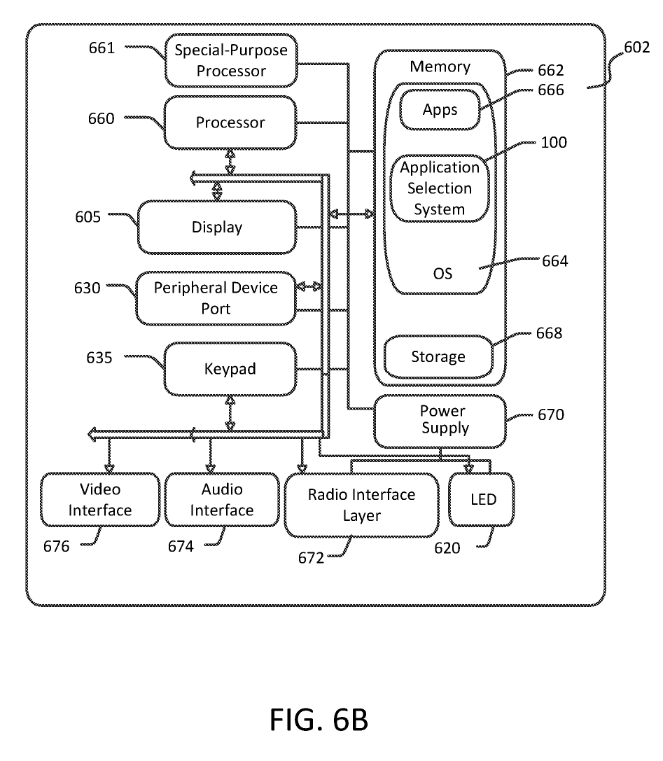

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666, the intelligent application selection system 100 runs on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

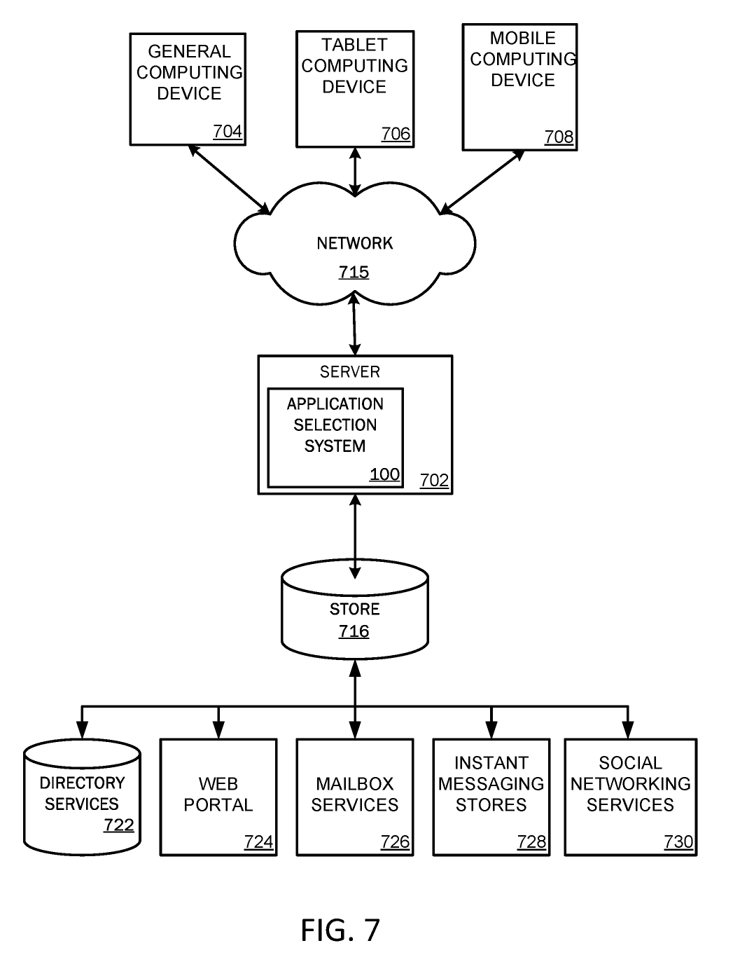

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, the intelligent application selection system 100 may be implemented in a general computing device 704, a tablet computing device 706 and/or a mobile computing device 708 (e.g., a smart phone). In some aspects, the server 702 is configured to implement an intelligent application selection system 100, via the network 715 as illustrated in FIG. 7.

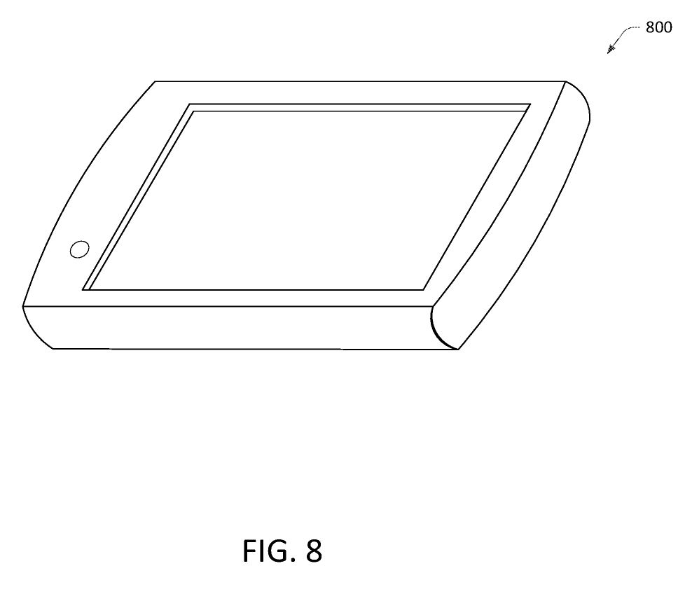

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage, and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A system for intelligent application selection, the system comprising:
at least one processor; and
a memory for storing and encoding computer executable instructions that, when executed by the at least one processor is operative to:
receive a uniform resource identifier (URI) selection for a URI;
extract a domain from the URI selection;
extract any URI augmentation from the URI selection;
collect user application preferences associated with the domain;
collect world application preferences associated with the domain;
rank any extracted URI augmentation, the user application preferences, and the world application preferences;
select an application for opening the URI based on the ranking; and
open the URI using the application.

2. The system of claim 1, wherein extract any URI augmentation from the URI selection comprises:
extracting no URI augmentations from the URI; or
extracting an augmentation from the URI that does not does not include a recommended application, and
wherein the any extracted URI augmentation is ranked below the user application preferences and the world application preferences.

3. The system of claim 1, wherein extract any URI augmentation from the URI selection comprises extracting a URI augmentation that includes a recommended application, and
wherein the any extracted URI augmentation is ranked above the user application preferences and the world application preferences.

4. The system of claim 1, wherein the user application preferences are determined utilizing machine learning and statistical analysis techniques based on user feedback, user application choices, and past user application patterns.

5. The system of claim 4, the at least one processor is operative to:
receive the use feedback;
track the user application choices; and
track the user application patterns.

6. The system of claim 1, wherein the world application preferences are determined utilizing machine learning and statistical analysis techniques based on world click patterns and compatibility knowledge.

7. The system of claim 6, wherein the compatibility knowledge is extracted from the world click patterns.

8. The system of claim 1, wherein the user application preferences with an assigned weight above a predetermined threshold are ranked above the world application preferences.

9. The system of claim 1, the at least one processor is further operative to:
assigning a weight to each extracted URI augmentation, to each user application preference and to each world application preference, and
wherein rank the any extracted URI augmentation, the user application preferences, and the world application preferences is based on the weight.

10. The system of claim 1, wherein the world application preferences are ranked above the user application preferences, when the user application preferences are based on very little or no user feedback and very little or no user application patterns.

11. The system of claim 1, wherein the application is:
a media player application;
a file sharing application;
a communication application;
a mapping application;
a digital assistant application;
a voice recognition application;
an email application;
a social networking application;
a collaboration application;
an enterprise management application;
a messaging application;
a word processing application;
a spreadsheet application;
a database application;
a presentation application;
a contacts application;
a gaming application;
an e-commerce application;
an e-business application;
a transactional application;
a device control application;
a web interface application;
an exchange application; or
a calendaring application.

12. A system for intelligent application selection, the system comprising:
at least one processor; and
a memory for storing and encoding computer executable instructions that, when executed by the at least one processor is operative to:
receive a uniform resource identifier (URI) selection for a URI;
extract a domain from the URI selection;
collect user application preferences associated with the domain;
collect world application preferences associated with the domain;
rank the user application preferences and the world application preferences;
select an application for opening the URI based on the ranking; and
provide a prompt to a user requesting approval to open the URI using the application.

13. The system of claim 12, the at least one processor is operative to:
receive user approval to the prompt; and
in response to the user approval, open the URI using the application.

14. The system of claim 12, the at least one processor is operative to:
receive user rejection to the prompt;
receive user selection of a different application; and
in response to the user selection, open the URI using the different application.

15. A method for intelligent application selection, the method comprising:
receiving a uniform resource identifier (URI) selection for a URI;
extracting a domain from the URI selection;
determining whether any URI application augmentation is associated with the URI;
in response to determining that the URI is not associated with a URI application augmentation:
collecting user application preferences associated with the domain;
collecting world application preferences associated with the domain;
ranking the user application preferences and the world application preferences;
selecting an application for opening the URI based on the ranking; and
opening the URI using the application.

16. The method of claim 15, the method further comprising:
in response to determining that the domain is associated with a URI augmentation:
identifying a recommended application by the URI application augmentation;
wherein the application is the recommended application.

17. The method of claim 15, wherein the user application preferences is based on user feedback.

18. The method of claim 15, wherein the user application preferences are determined utilizing machine learning and statistical analysis techniques based on user feedback and user application patterns.

19. The method of claim 18, wherein the URI is a uniform resource locator (URL) and the application is a web browser.

20. The method of claim 15, wherein the domain is a media player application.
